(19) United States
(12) Patent Application Publication
(10) Pub. No.: US 2008/0247525 A1
(43) Pub. Date: Oct. 9, 2008

(54) GAME-ON-HOLD

(76) Inventors: Christopher C. LeBlanc, Somerville, MA (US); Harun G. Gadatia, Billerica, MA (US); Devanjan Sarkar, Nashua, NH (US)

Correspondence Address: CISCO SYSTEMS, INC.;SCIENTIFIC-ATLANTA, INC., SA/CISCO IP DEPT., 5030 SUGARLOAF PARKWAY, LAWRENCEVILLE, GA, 30044, US

(21) Appl. No.: 11/697,348

(22) Filed: Apr. 6, 2007

(51) Int. Cl. H04M 11/00

(52) U.S. Cl. 379/101.01

(57) ABSTRACT

In one embodiment, a method includes receiving a call from a user at an endpoint, placing the user on hold in response to a particular event, and rendering one or more games that are playable by the user at the endpoint. The rendering of the one or more games enables the user to play one or more of the games while the user is on hold.

### TECHNICAL FIELD

The present disclosure relates generally to Internet Protocol (IP) telephony.

### BACKGROUND

Call-based customer service has become pervasive in modern society, especially in services which require direct communication with customers. Many call-handling systems include a call center that may include, among other things, an interactive voice response (IVR) and a number of live agents or attendants to assist the caller or user.

When no agent or attendant is available to assist the caller, the caller is placed in a holding queue, i.e., the caller is placed on hold. To keep the caller's interest, as well as indicate to the caller that he has not been disconnected while on hold, pre-recorded music and/or periodic messages are delivered to the caller.

### BRIEF DESCRIPTION OF THE DRAWINGS

To provide a more complete understanding of the present invention and features and advantages thereof, reference is made to the following description, taken in conjunction with the accompanying drawings, in which:

FIG. 1 illustrates an example system for providing one or more games to a caller while the caller is on hold; and

FIG. 2 illustrates an example method for providing one or more games to a caller while the caller is on hold.

### DESCRIPTION OF EXAMPLE EMBODIMENTS

Overview

In one embodiment, a method includes receiving a call from a user at an endpoint, placing the user on hold in response to a particular event, and rendering one or more games that are playable by the user at the endpoint. The rendering of the one or more games enables the user to play one or more of the games while the user is on hold.

Description

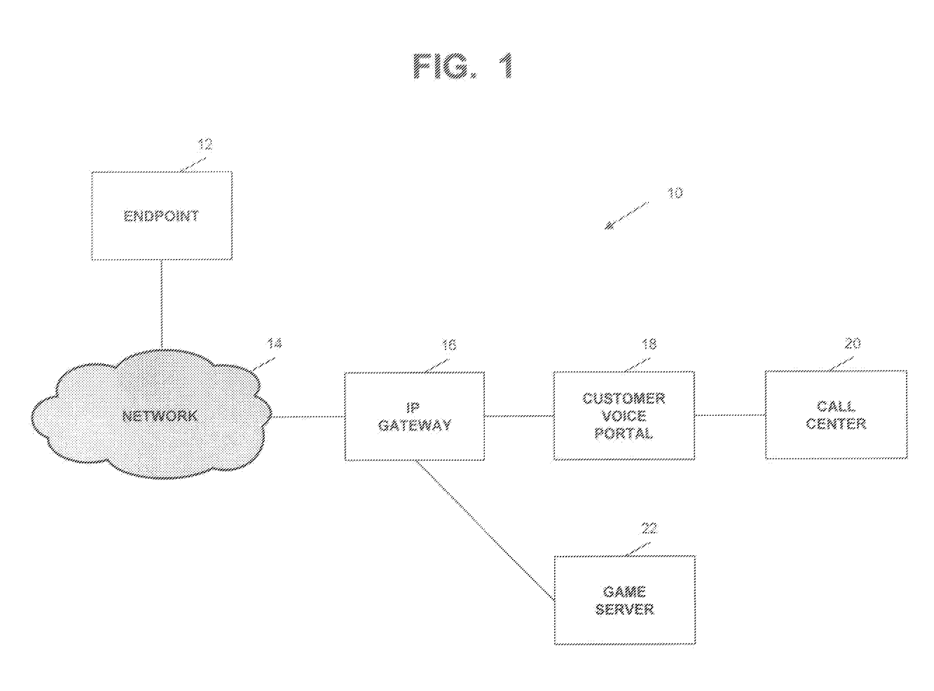

FIG. 1 illustrates an example system 10 for providing one or more games to a caller while the caller is on hold. System 10 includes a network 14 connecting at least one endpoint 12 to a call center 20 through an IP gateway 16 and customer voice portal 18. In particular embodiments, the network 14 is a local area network (LAN), a wide area network (WAN), a metropolitan area network (MAN), a portion of the Internet, or another network 14 or a combination of two or more such networks 14. In particular embodiments, network 14 has one or more connections to one or more other networks 14, such as, for example, the Public Switched Telephone Network (PSTN). The present invention contemplates any suitable network 14. Although the example system 10 is illustrated as including one endpoint 12, it will be understood that the system 10 may include more than one endpoint 12.

The endpoint 12 enables a user to communicate with others. The endpoint 12 comprises any suitable input/output device for transmitting and/or receiving voice, video, and data. In particular embodiments, the endpoint 12 may have a keyboard or a keypad for dialing numbers and entering commands, an electronically sensitive pad on which handwriting or stylus directions can be received, an audio command interface, and/or any other device or set of devices suitable for entering information or commands to the endpoint 12. In addition, the endpoint 12 may include a monitor or other display or graphical interface for displaying information associated with a call to the user. As an example and not by way of limitation, an endpoint 12 may be an IP or other digital telephone, cellular or other mobile telephone, a personal digital assistant (PDA), a computer or computing device, or any other device or set of devices capable of communicating voice, video, and data over the network 14. The present invention contemplates any suitable endpoint 12.

IP gateways 16 may be computers that route data traffic from an endpoint 12 via an outside network 14 to some destination, such as another endpoint or computer or to a call center 20. For example, telephony services (i.e., voice and facsimile) and video services can be transported over data networks. In particular embodiments of this invention, a routing unit resides at the IP gateway 16. When the IP gateway 16 is routing an IP telephony call, the routing unit determines whether the call destination is available to accept the IP telephony call, and if not, the IP gateway 16 may route the IP telephony call to another destination. The present invention contemplates that the routing unit may reside at any suitable device or location, including without limitation the customer voice portal 18 or call center 20.

In particular embodiments, a customer voice portal 18 is coupled to the IP gateway 16. In one embodiment, the customer voice portal 18 may include an interactive voice response (WR) that allows a user or caller to use an endpoint 12 to interact with a computer system. As an example and not by way of limitation, the IVR at the customer voice portal 18 plays a predetermined voice menu and prompts the user to select and/or enter the option chosen from the voice menu via the endpoint 12. The user may enter his or her selection by pressing a corresponding number on a keypad of the endpoint 12 or speaking simple answers such as “yes” or “no” or numbers in answer to the voice prompts. The present invention contemplates any suitable method of entering a response.

According to particular embodiments, in operation, if a call from an endpoint 12 is directed to a call center 20, but there is no agent or attendant at the call center 20 available to assist the user, the IP gateway 16 may place the call in a holding queue and route the call to another destination, such as a customer voice portal 18. The IVR at the customer voice portal 18 sends a voice message to the endpoint 12 to ask what, from a predetermined list of options, the user at the endpoint 12 would like to do. As an example and not by way of limitation, the IVR may offer to the user such options as playing a game from a list of many interactive games, such as, for example, trivia game, hangman, Tetris, or sudoku. The user is prompted to select and/or enter the option chosen from the voice menu via the endpoint 12. If the user selects a game, the IP gateway 16 connects the endpoint 12 to a game server 22.

A variety of games, including without limitation, video or interactive games, reside at a game server 22. In response to the endpoint 12 being on hold and the user having selected a game choice, the game server 22 makes the selected game available to the endpoint 12. When the final call destination can accept the call, the IP gateway 16 is signaled to disable the on hold status, to disconnect the endpoint 12 from the game server 22 and to complete the call, for example, between the endpoint 12 and the call center 20.

In particular embodiments, multiple endpoints 12 may be connected simultaneously to the game server 22. In other embodiments, the game server 22 may support multiplayer online games where the users may interact with other connected users, for example, to compete with or against other users.

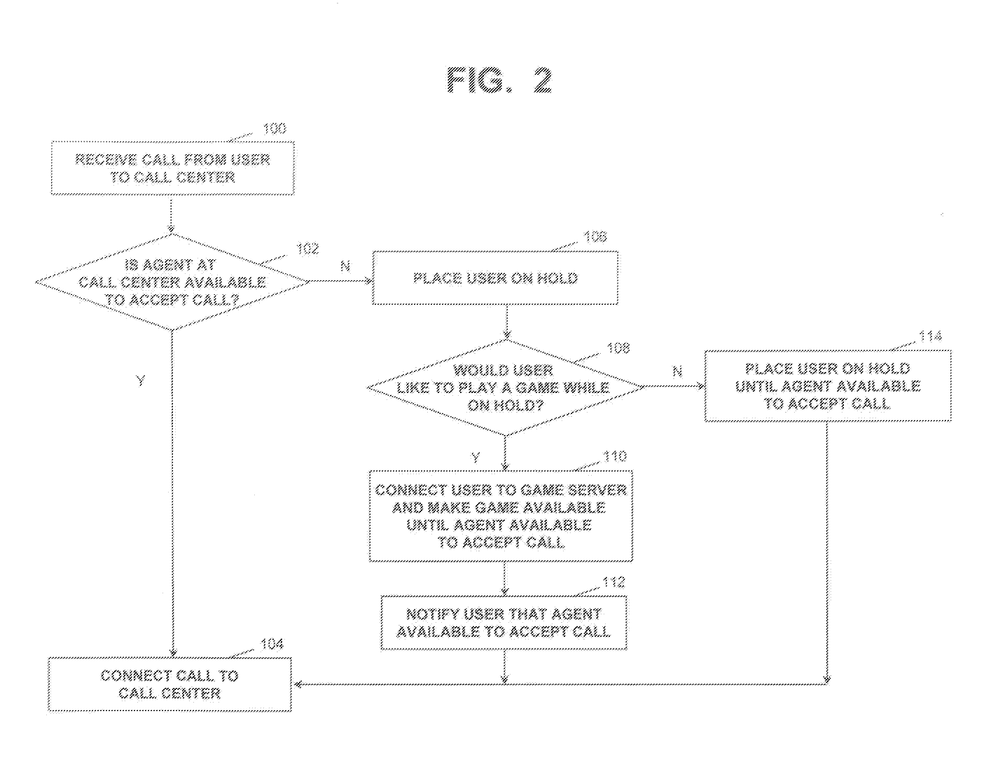

FIG. 2 illustrates an example method for providing one or more games to a caller while the caller is on hold. The method begins at step 100, where a call is received at an IP gateway 16 via a network 14 from a user at an endpoint 12. At step 102, a customer voice portal 18 determines whether an agent or attendant at the call center 20 is available to accept the call from the endpoint 12, and if so, the method proceeds to step 104. At step 104, the customer voice portal 18 routes the call to an available agent or attendant at the call center 20, and the method ends.

At step 102, if no agent or attendant at the call center 20 is available to accept the call, the method proceeds to step 106, and the customer voice portal 18 places the user at the endpoint 12 in a holding queue. At step 108, the customer voice portal 18 queries the user to determine whether the user wishes to play a game while such user is on hold, and if not, the method proceeds to step 114. At step 114, the user remains on hold until an agent or attendant at the call center 20 is available to accept the call and assist the user. When an agent or attendant at the call center 20 is available to accept the call and assist the user, the method proceeds to step 104, and the customer voice portal 18 routes the call to the available agent or attendant at the call center 20, and the method ends.

At step 108, if the user wishes to play a game while in the holding queue, the method proceeds to step 110. In particular embodiments, at step 110, the IP gateway 16 connects the endpoint 12 to a game server 22, which makes one or more games available to the user while such user is on hold. In alternative embodiments, the customer voice portal 18 connects the endpoint 12 to a game server 22. The games are playable to the user at the endpoint 12.

When an agent or attendant at the call center 20 is available to accept the call and assist the user, the method proceeds to step 112, and the customer voice portal 18 notifies the user of the available agent or attendant, removes the user from the holding queue, routes the call to the available agent or attendant at the call center 20, and the method ends. In alternative embodiments, when an agent or attendant at the call center 20 is available to accept the call and assist the user, the customer voice portal 18 queries the user to determine whether the user wishes to continue playing the game or to be connected to the available agent or attendant. If the user wishes to be connected to the available agent or attendant, the customer voice portal 18 removes the user from the holding queue and routes the call to the available agent or attendant at the call center 20, and the method ends. If not, the user remains in the holding queue, and the endpoint 12 remains connected to the game server 22. The games continue to be playable to the user at the endpoint 12 until once again, an agent or attendant at the call center 20 is available to accept a call. The customer voice portal 18 queries the user to determine whether the user wishes to continue playing the game or to be connected to the available agent or attendant. If so, the customer voice portal 18 removes the user from the holding queue and routes the call to the available agent or attendant at the call center 20, and the method ends. If not, the user remains in the holding queue, and the process will be repeated with respect to querying the user to determine whether he wishes to be connected to an available agent or attendant, unless and until the user responds affirmatively to be connected to an available agent or attendant.

Although particular components have been illustrated and described as carrying out particular steps of the method illustrated in FIG. 2, the present disclosure contemplates any suitable components carrying out any suitable steps of the method illustrated in FIG. 2. Moreover, although particular steps in the method illustrated in FIG. 2 have been illustrated and described as occurring in a particular order, the present invention contemplates any suitable steps of the method illustrated in FIG. 2 occurring in any suitable order.

The present disclosure encompasses all changes, substitutions, variations, alterations, and modifications to the example embodiments described herein that a person having ordinary skill in the art would comprehend. Similarly, where appropriate, the appended claims encompass all changes, substitutions, variations, alterations, and modifications to the example embodiments described herein that a person having ordinary skill in the art would comprehend.

What is claimed is:

1. An apparatus comprising:
an interface operable to receive a call from a user at an endpoint;
first logic and embodied in one or more tangible media for execution and when executed operable to:
place the user on hold in response to a particular event; and
connect the call to second logic embodied in one or more tangible media for execution and when executed operable to render one or more games that are playable by the user at the endpoint, connection of the call to the second logic enabling the user to play one or more of the games while the user is on hold; and
the second logic.

2. The apparatus of claim 1, wherein:
the interface resides at an Internet Protocol (IP) gateway;
the first logic resides at a customer voice portal (CVP) comprising interactive voice response (IVR) functionality; and
the second logic resides at a game server.

3. The apparatus of claim 1, wherein:
the call from the user comprises a call to a contact center; and
the particular event comprises an agent at the contact center being temporarily unavailable to take the call.

4. The apparatus of claim 1, wherein the first logic is further operable to:
present to the user an option of playing one or more games while the user is on hold; and
connect the call to second logic only if, in response to presentation of the option, the user provides input indicating that the user wants to play one or more games while the user is on hold.

5. The apparatus of claim 1, wherein:
the first logic is further operable to:
present to the user a menu of two or more games to play while the user is on hold;
receive from the user a selection of one of the two or more games; and
communicate the selection to the second logic; and
the second logic is further operable to render the selected game to enable the user to play the selected game while the user is on hold.

6. The apparatus of claim 1, wherein the first logic is further operable, in response to an agent becoming available to take the call, automatically and without user input:
disconnect the call from the second logic;
take the call off hold; and
connect the call to the agent.

7. The apparatus of claim 6, wherein:
the first logic is further operable to:
after the user has completed a transaction with the agent, present to the user an option of resuming a game that the user played while the user was previously on hold; and
reconnect the call to the second logic if the user provides input indicating that the user wants to resume the game; and
the second logic is further operable to render the game to enable the user to resume the game.

8. The apparatus of claim 1, wherein one or more of the games is a trivia game.

9. The apparatus of claim 1, wherein one or more of the games each comprises one or more graphical components displayable to the user at the endpoint.

10. The apparatus of claim 1, wherein, to play at least one of the games, the user uses a keypad at the endpoint to direct a character in the game.

11. The apparatus of claim 1, wherein:
the first logic is further operable to:
detect display functionality at the endpoint operable to support a game that comprises one or more graphical components; and
communicate an indication of the display functionality to the second logic; and
the second logic is further operable, according to the indication of the display functionality, to render a game comprising one or more graphical components to enable the user to play the game while the user is on hold.

12. A method comprising:
receiving a call from a user at an endpoint;
placing the user on hold in response to a particular event; and
rendering one or more games that are playable by the user at the endpoint, rendering of the one or more games enabling the user to play one or more of the games while the user is on hold.

13. The method of claim 12, wherein:
the interface resides at an Internet Protocol (IP) gateway;
the first logic resides at a customer voice portal (CVP) comprising interactive voice response (IVR) functionality; and
the second logic resides at a game server.

14. The method of claim 12, wherein:
the call from the user comprises a call to a contact center; and
the particular event comprises an agent at the contact center being temporarily unavailable to take the call.

15. The method of claim 12:
further comprising presenting to the user an option of playing one or more games while the user is on hold; and
wherein rendering one or more games that are playable by the user at the endpoint comprises rendering one or more games that are playable by the user at the endpoint only if, in response to presentation of the option, the user provides input indicating that the user wants to play one or more games while the user is on hold.

16. The method of claim 12:
further comprising:
presenting to the user a menu of two or more games to play while the user is on hold; and
receiving from the user a selection of one of the two or more games; and
wherein rendering one or more games that are playable by the user at the endpoint comprises rendering the selected game to enable the user to play the selected game while the user is on hold.

17. The method of claim 12, further comprising, in response to an agent becoming available to take the call, automatically and without user input:
disconnecting the call from the second logic;
taking the call off hold; and
connecting the call to the agent.

18. The method of claim 17, further comprising:
after the user has completed a transaction with the agent, presenting to the user an option of resuming a game that the user played while the user was previously on hold; and
if the user provides input indicating that the user wants to resume the game, rendering the game to enable the user to resume the game.

19. The method of claim 12, wherein one or more of the games is a trivia game.

20. The method of claim 12, wherein one or more of the games each comprises one or more graphical components displayable to the user at the endpoint.

21. The method of claim 12, wherein, to play at least one of the games, the user uses a keypad at the endpoint to direct a character in the game.

22. The method of claim 12, further comprising:
detecting display functionality at the endpoint operable to support a game that comprises one or more graphical components; and
wherein rendering one or more games that are playable by the user at the endpoint comprises rendering, according to the detected display functionality, a game comprising one or more graphical components to enable the user to play the game comprising one or more graphical components while the user is on hold.

23. A system comprising:
means for receiving a call from a user at an endpoint;
means for placing the user on hold in response to a particular event; and
means for rendering one or more games that are playable by the user at the endpoint, rendering of the one or more games enabling the user to play one or more of the games while the user is on hold.
